(19) United States
(12) Patent Application Publication
(10) Pub. No.: US 2026/0149478 A1
(43) Pub. Date: May 28, 2026

(54) WEARABLE DEVICE AND COMMUNICATION METHOD

(71) Applicant: HTC Corporation, Taoyuan City (TW)

(72) Inventors: Chun-Yih WU, Taoyuan City (TW); Ta-Chun PU, Taoyuan City (TW); Yen-Liang KUO, Taoyuan City (TW)

(73) Assignee: HTC Corporation, Taoyuan City (TW)

(21) Appl. No.: 19/008,272

(22) Filed: Jan. 2, 2025

(30) Foreign Application Priority Data
Nov. 22, 2024 (TW) 113145036

(51) Int. Cl. H04B 1/3827; H01Q 1/27; H01Q 5/307

(52) U.S. Cl. CPC H04B 1/3833; H01Q 1/273; H01Q 5/307

(57) ABSTRACT

A wearable device includes a receiver element, a first wave transmission structure, a second wave transmission structure, an impedance converter, a transmitter element, and a flexible wearable layer. The first wave transmission structure and the second wave transmission structure are adjacent to the receiver element. The receiver element is positioned between the first wave transmission structure and the second wave transmission structure. The impedance converter is adjacent to the first wave transmission structure. The transmitter element is adjacent to the impedance converter. The impedance converter is positioned between the first wave transmission structure and the transmitter element. The flexible wearable layer is configured to carry the receiver element, the first wave transmission structure, the second wave transmission structure, the impedance converter, and the transmitter element. A composite radiator is formed by the first wave transmission structure, the second wave transmission structure, and the transmitter element.

### CROSS REFERENCE TO RELATED APPLICATIONS

This application claims priority of Taiwan Patent Application No. 113145036 filed on Nov. 22, 2024, the entirety of which is incorporated by reference herein.

### BACKGROUND OF THE INVENTION

### Field of the Invention

The invention relates to a wearable device, and more particularly, to a wearable device and a communication method.

### Description of the Related Art

If the directivity of the radiation pattern of a wearable device with a communication function is too high, it may be difficult to use it for receiving and transmitting signals in a variety of directions. Accordingly, there is a need to propose a novel solution for solving this problem of the prior art.

### BRIEF SUMMARY OF THE INVENTION

In an exemplary embodiment, the invention is directed to a wearable device that includes a receiver element, a first wave transmission structure, a second wave transmission structure, an impedance converter, a transmitter element, and a flexible wearable layer. The first wave transmission structure and the second wave transmission structure are adjacent to the receiver element. The receiver element is positioned between the first wave transmission structure and the second wave transmission structure. The impedance converter is adjacent to the first wave transmission structure. The transmitter element is adjacent to the impedance converter. The impedance converter is positioned between the first wave transmission structure and the transmitter element. The flexible wearable layer is configured to carry the receiver element, the first wave transmission structure, the second wave transmission structure, the impedance converter, and the transmitter element. A composite radiator is formed by the first wave transmission structure, the second wave transmission structure, and the transmitter element.

In some embodiments, when the receiver element receives a wireless signal from a communication device, the composite radiator provides an almost omnidirectional radiation pattern. The communication device is a controller, a tracker, a watch, an IMU (Inertial Measurement Unit), an environmental sensor, a temperature sensor, or an HMD (Head Mounted Display).

In some embodiments, the wearable device covers an operational frequency band from 1 GHz to 10 GHz.

In some embodiments, the receiver element includes a plurality of main metal elements which are disposed adjacent to each other. Each of the main metal elements substantially has a large L-shape.

In some embodiments, the length of each of the main metal elements is from 0.2 to 0.6 wavelength of the operational frequency band.

In some embodiments, the distance between any two adjacent main metal elements is from 0.1 to 0.5 wavelength of the operational frequency band.

In some embodiments, the receiver element further includes a plurality of auxiliary metal elements which are disposed adjacent to each other. Each of the auxiliary metal elements substantially has a small L-shape.

In some embodiments, the auxiliary metal elements are substantially surrounded by the main metal elements.

In some embodiments, the first wave transmission structure includes a plurality of first metal elements which are arranged parallel to each other. Each of the first metal elements substantially has a straight-line shape.

In some embodiments, the length of each of the first metal elements is from 0.2 to 0.6 wavelength of the operational frequency band.

In some embodiments, the distance between any two adjacent first metal elements is from 0.1 to 0.2 wavelength of the operational frequency band.

In some embodiments, the second wave transmission structure includes a plurality of second metal elements which are arranged parallel to each other. Each of the second metal elements substantially has a straight-line shape.

In some embodiments, the length of each of the second metal elements is from 0.2 to 0.6 wavelength of the operational frequency band.

In some embodiments, the distance between any two adjacent second metal elements is from 0.1 to 0.2 wavelength of the operational frequency band.

In some embodiments, the impedance converter includes a conversion metal element, and the conversion metal element substantially has a U-shape.

In some embodiments, the length of the conversion metal element is from 0.2 to 0.6 wavelength of the operational frequency band.

In some embodiments, the transmitter element includes a first radiation metal element and a second radiation metal element. The second radiation metal element is adjacent to the first radiation metal element. The first radiation metal element and the second radiation metal element are symmetrical.

In some embodiments, each of the first radiation metal element and the second radiation metal element substantially has a bending shape.

In some embodiments, the length of each of the first radiation metal element and the second radiation metal element is substantially equal to 0.25 wavelength of the operational frequency band.

In another exemplary embodiment, the invention is directed to a communication method that includes the steps of: providing a receiver element, a first wave transmission structure, a second wave transmission structure, an impedance converter, and a transmitter element, wherein the first wave transmission structure and the second wave transmission structure are adjacent to the receiver element, wherein the receiver element is positioned between the first wave transmission structure and the second wave transmission structure, wherein the first wave transmission structure and the transmitter element are adjacent to the impedance converter, and wherein the impedance converter is positioned between the first wave transmission structure and the transmitter element; carrying the receiver element, the first wave transmission structure, the second wave transmission structure, the impedance converter, and the transmitter element by a flexible wearable layer; and forming a composite radiator by the first wave transmission structure, the second wave transmission structure, and the transmitter element.

### BRIEF DESCRIPTION OF DRAWINGS

The invention can be more fully understood by reading the subsequent detailed description and examples with references made to the accompanying drawings, wherein:

FIG. 1 is a diagram of a wearable device and a communication device according to an embodiment of the invention;

FIG. 2A is a partially sectional view of a wearable device according to an embodiment of the invention;

FIG. 2B is a partially sectional view of a wearable device according to another embodiment of the invention;

FIG. 2C is a partially sectional view of a wearable device according to other embodiments of the invention;

FIG. 3 is a diagram of a wearable device and a communication device according to an embodiment of the invention;

FIG. 4 is a diagram of a wearable device and a communication device according to an embodiment of the invention; and

FIG. 5 is a flowchart of a communication method according to an embodiment of the invention.

### DETAILED DESCRIPTION OF THE INVENTION

In order to illustrate the foregoing and other purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

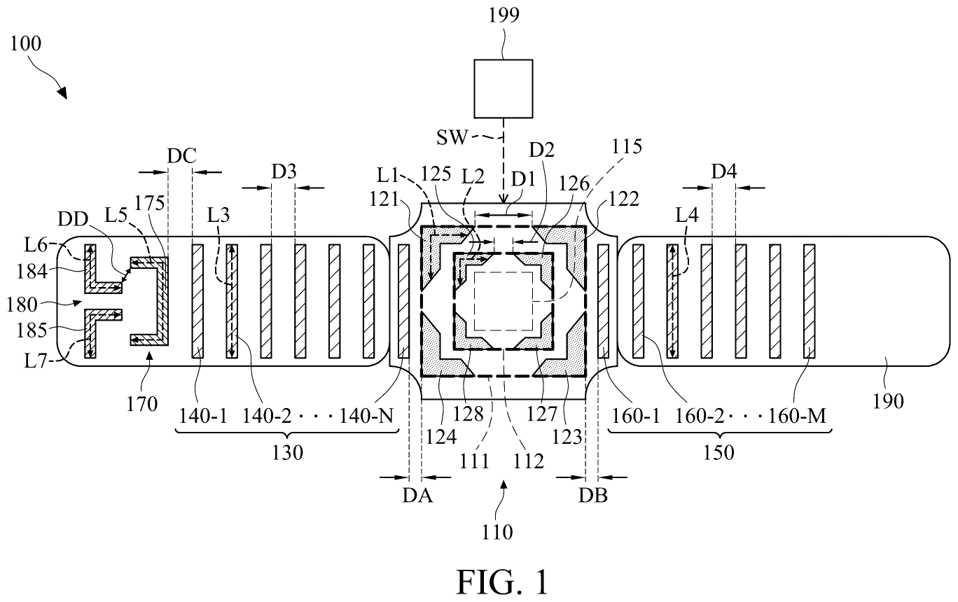

FIG. 1 is a diagram of a wearable device 100 and a communication device 199 according to an embodiment of the invention. The wearable device 100 and the communication device 199 may be two different devices which are independent of each other. For example, the communication device 199 may be implemented with a controller or a tracker for detecting related parameters of movements or rotations of a human body. In addition, the wearable device 100 is configured to carry the communication device 199 and improve the communication quality of the communication device 199. As shown in FIG. 1, the wearable device 100 at least includes a receiver element 110, a first wave transmission structure 130, a second wave transmission structure 150, an impedance converter 170, a transmitter element 180, and a flexible wearable layer 190. The receiver element 110, the first wave transmission structure 130, the second wave transmission structure 150, the impedance converter 170, and the transmitter element 180 may all be made of conductive materials, such as copper, silver, aluminum, iron, or their alloys. It should be understood that the wearable device 100 may include other components, such as a buckle element or a protection housing, although they are not displayed in FIG. 1.

The receiver element 110 includes a plurality of main metal elements 121, 122, 123 and 124 which are disposed adjacent to each other. For example, each of the main metal elements 121, 122, 123 and 124 may substantially have a large L-shape. In some embodiments, the main metal elements 121, 122, 123 and 124 are positioned at four corners of a first virtual square shape 111, respectively. It should be noted that the term “adjacent” or “close” over the disclosure means that the distance (spacing) between two corresponding elements is smaller than a predetermined distance (e.g., 10 mm or the shorter), but often does not mean that the two corresponding elements directly touch each other (i.e., the aforementioned distance/spacing between them is reduced to 0).

Also, the receiver element 110 may further include a plurality of auxiliary metal elements 125, 126, 127 and 128 which disposed adjacent to each other. The auxiliary metal elements 125, 126, 127 and 128 are substantially surrounded by the main metal elements 121, 122, 123 and 124. For example, each of the auxiliary metal elements 125, 126, 127 and 128 may substantially have a small L-shape (compared with the main metal elements 121, 122, 123 and 124). In some embodiments, the auxiliary metal elements 125, 126, 127 and 128 are positioned at four corners of a second virtual square shape 112, respectively. The area of the second virtual square shape 112 may be smaller than that of the first virtual square shape 111. In some embodiments, when the wearable device 100 and the communication device 199 are used together, the communication device 199 is disposed inside a target region 115 which is surrounded by the first virtual square shape 111 and the second virtual square shape 112. Thus, the wearable device 100 can communicate with the communication device 199. However, the invention is not limited thereto. In alternative embodiments, the total number of main metal elements 121, 122, 123 and 124 and auxiliary metal elements 125, 126, 127 and 128 is adjustable according to different requirements. It should be understood that the auxiliary metal elements 125, 126, 127 and 128 are optional components, which are omitted in other embodiments.

The first wave transmission structure 130 is adjacent to the receiver element 110. Specifically, the first wave transmission structure 130 includes a plurality of first metal elements 140-1, 140-2, . . . , and 140-N, where “N” is a positive integer greater than or equal to 5. The first metal elements 140-1, 140-2, . . . , and 140-N are separate from each other, and they are also arranged parallel to each other. For example, each of the first metal elements 140-1, 140-2, . . . , and 140-N may substantially have a straight-line shape.

The second wave transmission structure 150 is adjacent to the receiver element 110. The receiver element 110 is positioned between the first wave transmission structure 130 and the second wave transmission structure 150. Specifically, the second wave transmission structure 150 includes a plurality of second metal elements 160-1, 160-2, . . . , and 160-M, where “M” is a positive integer greater than or equal to 5. The second metal elements 160-1, 160-2, . . . , and 160-M are separate from each other, and they are also arranged parallel to each other. For example, each of the second metal elements 160-1, 160-2, . . . , and 160-M may substantially have another straight-line shape.

The impedance converter 170 is adjacent to the first wave transmission structure 130. Specifically, the impedance converter 170 includes a conversion metal element 175. For example, the conversion metal element 175 may substantially have a U-shape, but it is not limited thereto. It should be understood that the impedance converter 170 is configured to suppress the non-ideal reflection between the first wave transmission structure 130 and the transmitter element 180.

The transmitter element 180 is adjacent to the impedance converter 170. The impedance converter 170 is positioned between the first wave transmission structure 130 and the transmitter element 180. Specifically, the transmitter element 180 includes a first radiation metal element 184 and a second radiation metal element 185. The second radiation metal element 185 is adjacent to the first radiation metal element 184. In some embodiments, the first radiation metal element 184 and the second radiation metal element 185 are symmetrical. Each of the first radiation metal element 184 and the second radiation metal element 185 may substantially have a bending shape, such as an L-shape, but it is not limited thereto.

The flexible wearable layer 190 is configured to carry the receiver element 110, the first wave transmission structure 130, the second wave transmission structure 150, the impedance converter 170, and the transmitter element 180. In some embodiments, the flexible wearable layer 190 is implemented with a nonconductive ring carrier, and it is worn by any body part of a user.

In a preferred embodiment, a composite radiator of the wearable device 100 is formed by the first wave transmission structure 130, the second wave transmission structure 150, and the transmitter element 180. When the receiver element 110 receives a wireless signal SW from the communication device 199, the composite radiator of the wearable device 100 can provide an almost omnidirectional radiation pattern. According to practical measurements, the proposed wearable device 100 of the invention can help the communication device 199 to receive or transmit electromagnetic waves in a variety of directions, thereby effectively improving the overall communication quality of the communication device 199.

In some embodiments, the wearable device 100 can cover an operational frequency band. The operational frequency band may be from 1 GHz to 10 GHz. The frequency of the wireless signal SW may also fall within the operational frequency band. It should be understood that the range of the operational frequency band is adjustable according to different requirements.

In some embodiments, the element sizes of the wearable device 100 will be described as follows. The length L1 of each of the main metal elements 121, 122, 123 and 124 may be from 0.2 to 0.6 wavelength (0.2λ˜0.6λ) of the operational frequency band of the wearable device 100. The distance D1 between any adjacent two of the main metal elements 121, 122, 123 and 124 may be from 0.1 to 0.5 wavelength (0.1λ˜0.5λ) of the operational frequency band of the wearable device 100. The length L2 of each of the auxiliary metal elements 125, 126, 127 and 128 may be from 0.1 to 0.4 wavelength (0.1λ˜0.4λ) of the operational frequency band of the wearable device 100. The distance D2 between any adjacent two of the auxiliary metal elements 125, 126, 127 and 128 may be from 0.1 to 0.3 wavelength (0.1λ˜0.3λ) of the operational frequency band of the wearable device 100. The length L3 of each of the first metal elements 140-1, 140-2, . . . , and 140-N may be from 0.2 to 0.6 wavelength (0.2λ˜0.6λ) of the operational frequency band of the wearable device 100. The distance D3 between any adjacent two of the first metal elements 140-1, 140-2, . . . , and 140-N may be from 0.1 to 0.2 wavelength (0.1λ˜0.2λ) of the operational frequency band of the wearable device 100. The length L4 of each of the second metal elements 160-1, 160-2, . . . , and 160-M may be from 0.2 to 0.6 wavelength (0.2λ˜0.6λ) of the operational frequency band of the wearable device 100. The distance D4 between any adjacent two of the second metal elements 160-1, 160-2, . . . , and 160-M may be from 0.1 to 0.2 wavelength (0.1λ˜0.2λ) of the operational frequency band of the wearable device 100. The length L5 of the conversion metal element 175 may be from 0.2 to 0.6 wavelength (0.2λ˜0.6λ) of the operational frequency band of the wearable device 100. The length L6 of the first radiation metal element 184 may be substantially equal to 0.25 wavelength (0.25λ) of the operational frequency band of the wearable device 100. The length L7 of the second radiation metal element 185 may be substantially equal to 0.25 wavelength (0.25λ) of the operational frequency band of the wearable device 100. The distance DA between the receiver element 110 and the first wave transmission structure 130 may be from 0.1 to 0.2 wavelength (0.1λ˜0.2λ) of the operational frequency band of the wearable device 100. The distance DB between the receiver element 110 and the second wave transmission structure 150 may be from 0.1 to 0.2 wavelength (0.1λ˜0.2λ) of the operational frequency band of the wearable device 100. The distance DC between the first wave transmission structure 130 and the impedance converter 170 may be from 0.1 to 0.2 wavelength (0.1λ˜0.2λ) of the operational frequency band of the wearable device 100. The distance DD between the impedance converter 170 and the transmitter element 180 may be from 0.01 to 0.1 wavelength (0.01λ˜0.1λ) of the operational frequency band of the wearable device 100. The above ranges of element sizes are calculated and obtained according to many experimental results, and they help to optimize the omnidirectional characteristics of the radiation pattern of the wearable device 100.

The following embodiments will introduce different configurations and detail structural features of the wearable device 100. It should be understood that these figures and descriptions are merely exemplary, rather than limitations of the invention.

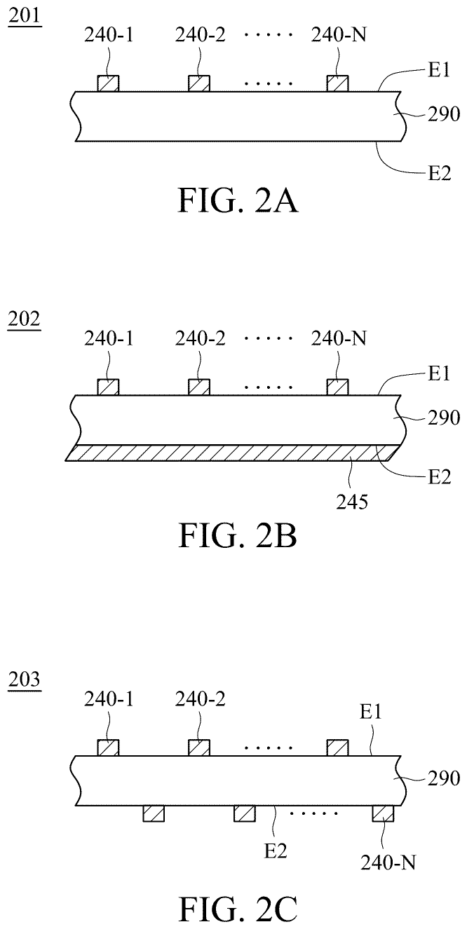

FIG. 2A is a partially sectional view of a wearable device 201 according to an embodiment of the invention. In the embodiment of FIG. 2A, a flexible wearable layer 290 of the wearable device 201 has a first surface E1 and a second surface E2 which are opposite to each other. A plurality of first metal elements 240-1, 240-2, . . . , and 240-N are merely disposed on the first surface E1 of the flexible wearable layer 290. On the contrary, there is no metal element disposed on the second surface E2 of the flexible wearable layer 290.

FIG. 2B is a partially sectional view of a wearable device 202 according to another embodiment of the invention. In the embodiment of FIG. 2B, the wearable device 202 further includes a ground metal plane 245. A plurality of first metal elements 240-1, 240-2, . . . , and 240-N are disposed on the first surface E1 of the flexible wearable layer 290. The ground metal plane 245 is disposed on the second surface E2 of the flexible wearable layer 290.

FIG. 2C is a partially sectional view of a wearable device 203 according to other embodiments of the invention. In the embodiment of FIG. 2C, a plurality of first metal elements 240-1, 240-2, . . . , and 240-N are distributed over both the first surface E1 and the second surface E2 of the flexible wearable layer 290. The first metal elements 240-1, 240-2, . . . , and 240-N may also be interleaved with each other. According to practical measurements, the arrangements of FIG. 2A, FIG. 2B and FIG. 2C can provide similar performance of wave transmission. It should be understood that a plurality of second metal elements (not shown) may be arranged on the flexible wearable layer 290 in a similar way.

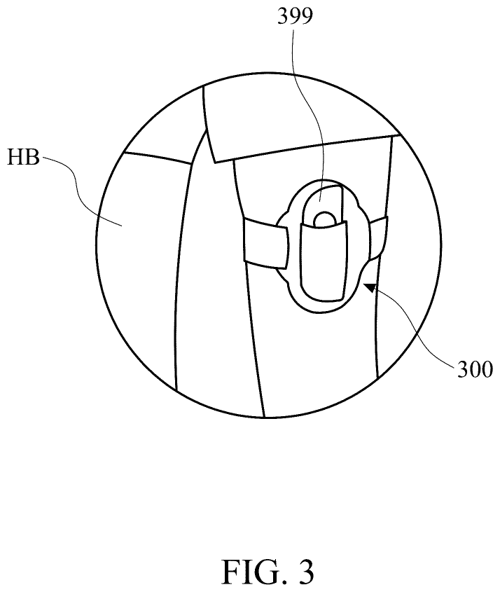

FIG. 3 is a diagram of a wearable device 300 and a communication device 399 according to an embodiment of the invention. In the embodiment of FIG. 3, the communication device 399 is disposed on the wearable device 300, and the wearable device 300 is worn by a leg of a human body HB. When the human body HB moves or changes posture, the communication quality of the communication device 399 may be negatively affected. At this time, the wearable device 300 is configured to overcome the aforementioned drawback of the communication device 399. Please refer to the following embodiments.

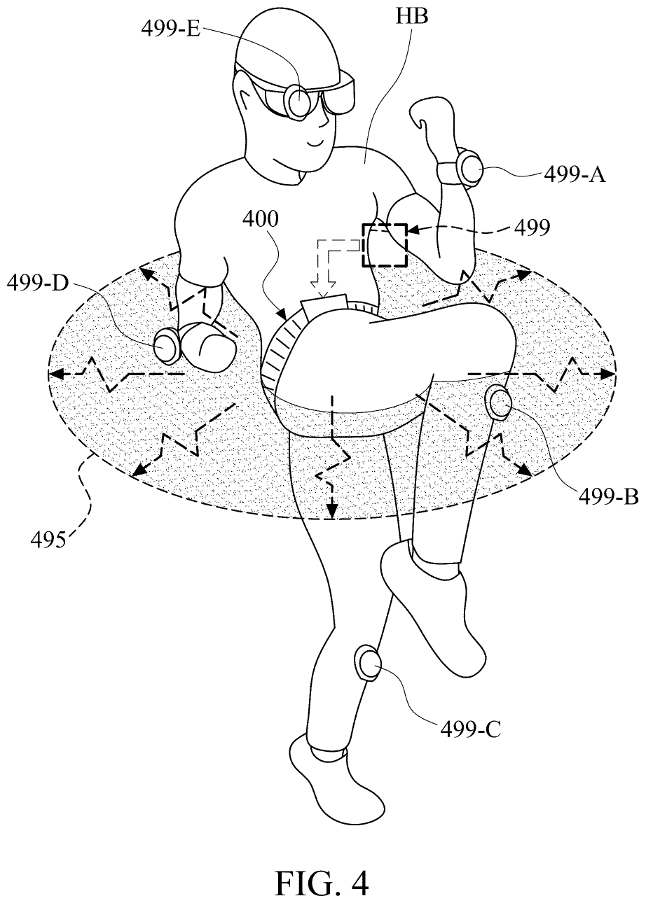

FIG. 4 is a diagram of a wearable device 400 and a communication device 499 according to an embodiment of the invention. In the embodiment of FIG. 4, when the wearable device 400 is worn by the human body HB, there can be a coupling mechanism induced between the wearable device 400 and the communication device 499. The wearable device 400 is configured to carry the communication device 499 (e.g., the communication device 499 may be disposed at the position indicated by the dashed arrow of FIG. 4). The communication device 499 may be a controller or a tracker. According to practical measurements, a composite radiator of the wearable device 400 can help the communication device 499 to provide an almost omnidirectional radiation pattern 495, thereby receiving or transmitting electromagnetic waves in a variety of directions. In other words, the communication quality of the communication device 499 can be significantly improved by using the wearable device 400. In alternative embodiments, there can be another coupling mechanism induced between the wearable device 400 and any one of different communication devices 499-A, 499-B, 499-C, 499-D and 499-E. Specifically, the communication device 499-A may be a watch, the communication device 499-B may be an IMU (Inertial Measurement Unit), the communication device 499-C may be an environmental sensor, the communication device 499-D may be a temperature sensor, and the communication device 499-E may be an HMD (Head Mounted Display). For example, the aforementioned HMD may be applied to the technical field of VR (Virtual Reality), AR (Augmented Reality), or XR (Extended Reality), but it is not limited thereto.

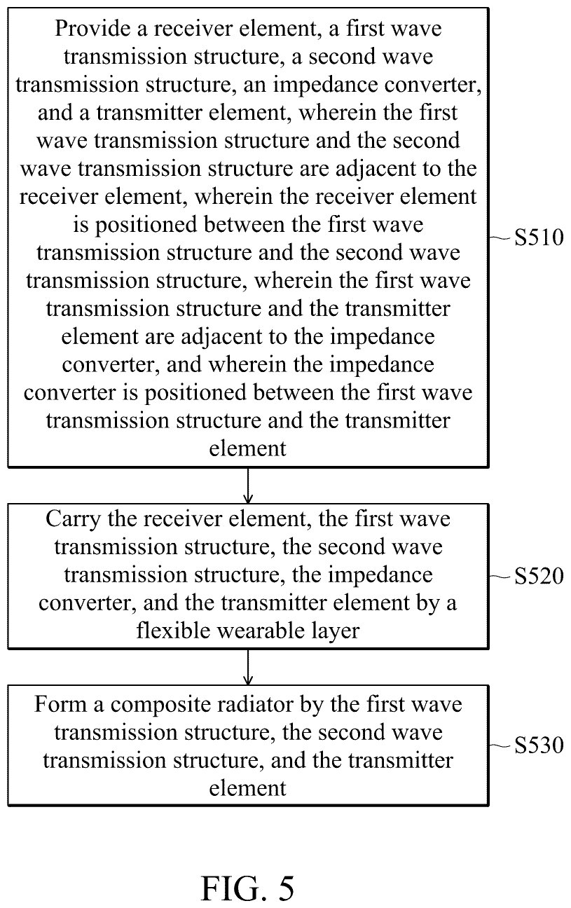

FIG. 5 is a flowchart of a communication method according to an embodiment of the invention. To begin, in step S510, a receiver element, a first wave transmission structure, a second wave transmission structure, an impedance converter, and a transmitter element are provided. The first wave transmission structure and the second wave transmission structure are adjacent to the receiver element. The receiver element is positioned between the first wave transmission structure and the second wave transmission structure. The first wave transmission structure and the transmitter element are adjacent to the impedance converter. The impedance converter is positioned between the first wave transmission structure and the transmitter element. In step S520, the receiver element, the first wave transmission structure, the second wave transmission structure, the impedance converter, and the transmitter element are carried by a flexible wearable layer. Finally, in step S530, a composite radiator is formed by the first wave transmission structure, the second wave transmission structure, and the transmitter element. It should be understood that these steps are not required to be performed in order, and every feature of the embodiments of FIGS. 1-4 may be applied to the communication method of FIG. 5.

The invention proposes a novel wearable device and a novel communication method. In comparison to the conventional design, the invention has at least the advantage of providing an almost omnidirectional radiation pattern. Therefore, the invention is suitable for application in a variety of devices.

Note that the above element sizes and element parameters are not limitations of the invention. A designer can fine-tune these setting values according to different requirements. It should be understood that the wearable device and the communication method of the invention are not limited to the configurations of FIGS. 1-5. The invention may include any one or more features of any one or more embodiments of FIGS. 1-5. In other words, not all of the features displayed in the figures should be implemented in the wearable device and the communication method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A wearable device, comprising:
a receiver element;
a first wave transmission structure, disposed adjacent to the receiver element;
a second wave transmission structure, disposed adjacent to the receiver element, wherein the receiver element is positioned between the first wave transmission structure and the second wave transmission structure;
an impedance converter, disposed adjacent to the first wave transmission structure;
a transmitter element, disposed adjacent to the impedance converter, wherein the impedance converter is positioned between the first wave transmission structure and the transmitter element; and
a flexible wearable layer, carrying the receiver element, the first wave transmission structure, the second wave transmission structure, the impedance converter, and the transmitter element;
wherein a composite radiator is formed by the first wave transmission structure, the second wave transmission structure, and the transmitter element.

2. The wearable device as claimed in claim 1, wherein when the receiver element receives a wireless signal from a communication device, the composite radiator provides an almost omnidirectional radiation pattern.

3. The wearable device as claimed in claim 2, wherein the communication device is a controller, a tracker, a watch, an IMU (Inertial Measurement Unit), an environmental sensor, a temperature sensor, or an HMD (Head Mounted Display).

4. The wearable device as claimed in claim 1, wherein the wearable device covers an operational frequency band from 1 GHz to 10 GHz.

5. The wearable device as claimed in claim 4, wherein the receiver element comprises:
a plurality of main metal elements, disposed adjacent to each other, wherein each of the main metal elements substantially has a large L-shape.

6. The wearable device as claimed in claim 5, wherein a length of each of the main metal elements is from 0.2 to 0.6 wavelength of the operational frequency band.

7. The wearable device as claimed in claim 5, wherein a distance between any two adjacent main metal elements is from 0.1 to 0.5 wavelength of the operational frequency band.

8. The wearable device as claimed in claim 5, wherein the receiver element further comprises:
a plurality of auxiliary metal elements, disposed adjacent to each other, wherein each of the auxiliary metal elements substantially has a small L-shape.

9. The wearable device as claimed in claim 8, wherein the auxiliary metal elements are substantially surrounded by the main metal elements.

10. The wearable device as claimed in claim 4, wherein the first wave transmission structure comprises:
a plurality of first metal elements, arranged parallel to each other, wherein each of the first metal elements substantially has a straight-line shape.

11. The wearable device as claimed in claim 10, wherein a length of each of the first metal elements is from 0.2 to 0.6 wavelength of the operational frequency band.

12. The wearable device as claimed in claim 10, wherein a distance between any two adjacent first metal elements is from 0.1 to 0.2 wavelength of the operational frequency band.

13. The wearable device as claimed in claim 4, wherein the second wave transmission structure comprises:
a plurality of second metal elements, arranged parallel to each other, wherein each of the second metal elements substantially has a straight-line shape.

14. The wearable device as claimed in claim 13, wherein a length of each of the second metal elements is from 0.2 to 0.6 wavelength of the operational frequency band.

15. The wearable device as claimed in claim 13, wherein a distance between any two adjacent second metal elements is from 0.1 to 0.2 wavelength of the operational frequency band.

16. The wearable device as claimed in claim 4, wherein the impedance converter comprises:
a conversion metal element, wherein the conversion metal element substantially has a U-shape.

17. The wearable device as claimed in claim 16, wherein a length of the conversion metal element is from 0.2 to 0.6 wavelength of the operational frequency band.

18. The wearable device as claimed in claim 4, wherein the transmitter element comprises:
a first radiation metal element; and
a second radiation metal element, disposed adjacent to the first radiation metal element, wherein the first radiation metal element and the second radiation metal element are symmetrical.

19. The wearable device as claimed in claim 18, wherein each of the first radiation metal element and the second radiation metal element substantially has a bending shape.

20. The wearable device as claimed in claim 18, wherein a length of each of the first radiation metal element and the second radiation metal element is substantially equal to 0.25 wavelength of the operational frequency band.

21. A communication method, comprising the steps of:
providing a receiver element, a first wave transmission structure, a second wave transmission structure, an impedance converter, and a transmitter element, wherein the first wave transmission structure and the second wave transmission structure are adjacent to the receiver element, wherein the receiver element is positioned between the first wave transmission structure and the second wave transmission structure, wherein the first wave transmission structure and the transmitter element are adjacent to the impedance converter, and wherein the impedance converter is positioned between the first wave transmission structure and the transmitter element;
carrying the receiver element, the first wave transmission structure, the second wave transmission structure, the impedance converter, and the transmitter element by a flexible wearable layer; and
forming a composite radiator by the first wave transmission structure, the second wave transmission structure, and the transmitter element.
